(19) United States
(12) Patent Application Publication
(10) Pub. No.: US 2004/0076500 A1
(43) Pub. Date: Apr. 22, 2004

(54) Portable, powered vehicular wheelchair lift

(75) Inventor: Richard Loy Coppersmith, Lexington, KY (US)

Correspondence Address: RICHARD LOY COPPERSMITH, 677 SMUGGLERS NORTH DR., LEXINGTON, KY, 40509, US

(73) Assignee: Mr. Richard Loy Coppersmith, Lexington, KY

(21) Appl. No.: 10/270,881

(22) Filed: Oct. 16, 2002

(51) Int. Cl. B60P 1/00

(52) U.S. Cl. 414/540

(57) ABSTRACT

A portable apparatus for lifting an object, such as a wheelchair, between an upper and lower position, such as a vehicle. An electric lifting device with an independent power source, such as a battery, which is continually charged using a cigarette lighter or auxiliary power source, with a temporary connecting device, such as a quick disconnect, from said vehicle. The base is solely connected by use of temporary mechanical attachments to the vehicle seat mounting pins. The apparatus also incorporates a sliding action of the platforms which enables clearance over physical objects of the vehicle, such as a bumper. The apparatus also preferably includes a folding assembly for moving in a compact configuration.

### BACKGROUND OF INVENTION

1. Field of the Invention

This invention consists of temporary mechanical and electrical connections which enable the portability of said lift. Present inventions consists of permanent attachment devises, both mechanically and electrically.

2. Description of the Prior Art

Vehicular wheelchair lifts commonly are attached by means of mechanical attachment, such as bolts, mounted through the floor or frame of the vehicle, thus providing a desired maintained position. Vehicular wheelchair lifts also are commonly powered by means of direct connection to the electrical system of the vehicle it resides in.

U.S. Pat. No. 5,253,973 issued to Fretwell on Oct. 19, 1993 discloses a lift for attachment to a vehicle. The lift is affixed to an unequal modified parallelogram structure, the combination being supported on movable rails and carried by rollers for movement by an electric motor.

U.S. Pat. No. 6,053,693 issued to Ringdahl, et al. on Apr. 25, 2000 discloses a Collapsible, powered platform for lifting wheelchair. The lift includes at least three pivotally connected sections. The sections are selectively movable between an unfolded and a folded orientation. The lift consists of a permanently mounted design.

U.S. Pat. No. 6,379,102 issued to Kameda Apr. 30, 2002 discloses a Wheelchair lift with a foldable platform. The lift includes a mounting assembly mounted to the vehicle floor adjacent to the vehicle opening. The wheelchair lift further has a pivotal linkage assembly for facilitating the unfolding of the platform assembly as the platform assembly moves from the swing-down deployment motion.

### Summary of Invention

The present invention is a portable, powered vehicular wheelchair lift for convenient installation, removal or transferring of the said device

It has a base frame with hook bolts connecting to the vehicle seat mounting pins. The base frame has at least four rollers connected to it to enable sliding action of the base platform and is located directly on top of the base frame. Sliding action is needed to clear objects, such as the bumper when pulled out, if lift is located in the rear of the vehicle. Sliding action is also needed to allow for door clearance when lift is in the pushed in position.

In addition to the mechanical attachment, the lift has an independent power source, such as a battery, which is connected to the vehicle's cigarette lighter or auxiliary power, by means of a quick disconnecting device, which continually charges the independent power supply.

It is a further objective of this invention to provide a collapsible means for compact storage by use of pivotal sections.

### BRIEF DESCRIPTION OF DRAWINGS

Referring to FIG. 1, the base frame (2) is mounted beneath the base platform (8).

In this illustration the lift is in the retracted position. Referring to FIG. 2, the base platform (8) is in the extended position.

Referring to FIG. 1 and FIG. 2, the battery (1) and lighter plug (5) comprise the independent power supply with a temporary means of connection for charging.

Referring to FIG. 1 and FIG. 2, the pivotal points (6) indicate the needed pivotal points to collapse the lift.

Referring to FIG. 3, view (A) shows a cut view of the base frame (2). FIG. 3 also shows the mounting devises, such as the base frame mounting bar (1), vehicle seat mounting pins (4) and the base frame mounting bolts and nuts (5).

FIG. 4 shows the base platform (6) in it's working location with the base frame (2). FIG. 4 also shows the configuration of the base platform (6) and the base frame rollers (3), which allow the base platform (6) to be slid into it's extended position.

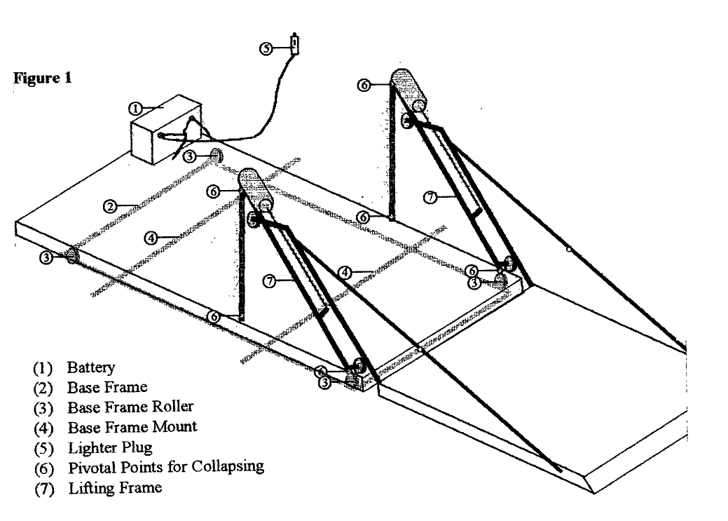

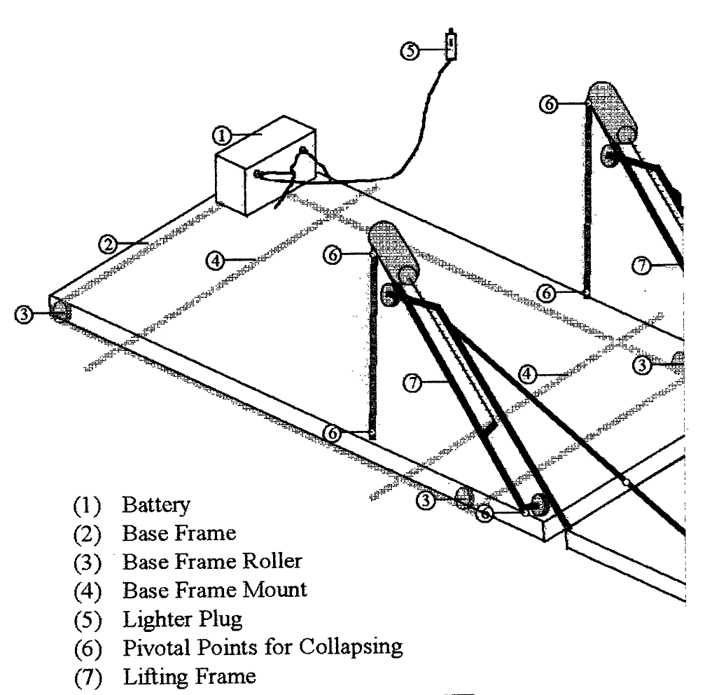

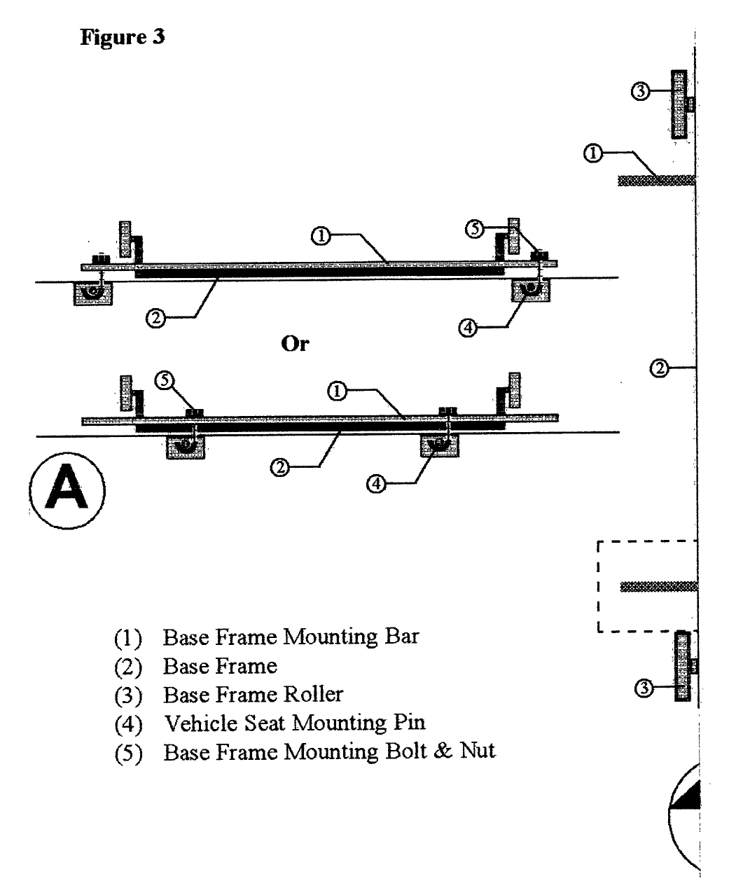

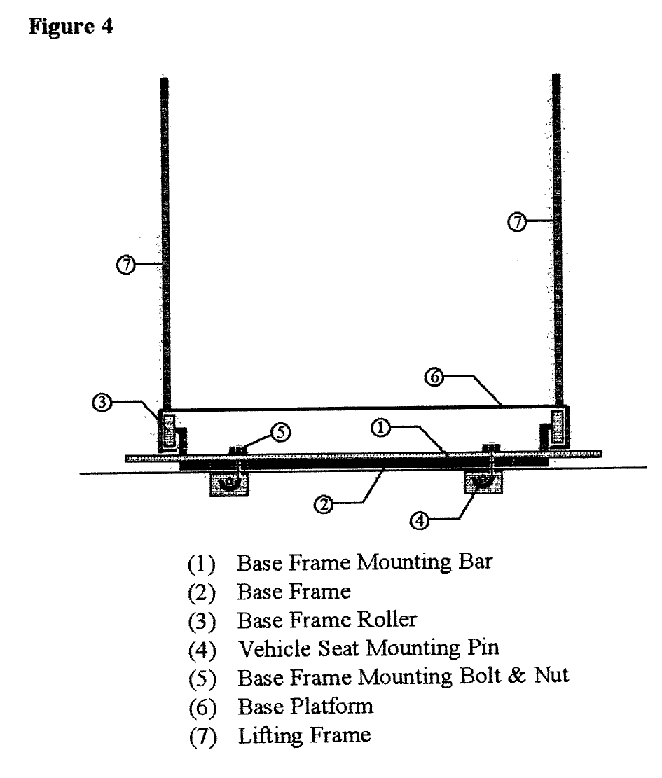

### DETAILED DESCRIPTION

A powered vehicular wheelchair lift for convenient installation, removal or transferring of the said device.

The device is comprised of two main elements which contribute to it's portability:

1. Mechanical Attachment

The mechanical attachment is achieved by means of a mounting bar which is attached to the base frame, by friction and placement, and to the vehicle seat mounting pins by means of mechanical attachment, such as a hook bolt.

2. Power Source

The power source is achieved by means of an independent power supply, such as a battery. Said power supply is connected and continually charged by means of temporary connection to the cigarette lighter or auxiliary power supply in the vehicle. Intermediate power supply needed by the lifting apparatus is supplied by the independent power supply of said lift. Continually charging of the independent power supply by said means restores used power for continuing use.

Operation

This wheelchair lift is designed to slide out, when in use, for clearance over physical obstructions, such as a vehicle bumper. It is designed to include the use of rear vehicle operation, such as the rear of a van.

What is claimed is:

1. A PORTABLE LIFT OF CLAIM 1;
A portable lift apparatus used in a vehicle for moving an object between the floor of a vehicle and ground level, the portable features of the lift apparatus comprising:
TEMPORARY MOUNTING DEVISES;
The mechanical attachment is achieved by means of a mounting bar which is attached to the base frame, by friction and placement, and to the vehicle seat mounting pins by means of a fastening device, such as a hook bolt.
A PORTABLE POWER SOURCE;
Supplying power to the lift is an independent source, such as a battery. Said power source is connected and continually charged by means of temporary connection to the cigarette lighter or auxiliary power supply in the vehicle.

2. A SLIDING PLATFORM OF claim 2;
This wheelchair lift is designed to slide out, when in use, for clearance over physical obstructions, such as a vehicle bumper.
